(19) United States
(12) Patent Application Publication
(10) Pub. No.: US 2004/0144235 A1
(43) Pub. Date: Jul. 29, 2004

(54) Data processing method in a tuner and tuner using the method

(76) Inventor: Takeo Taku, Tokyo (JP)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 10/742,408

(22) Filed: Dec. 19, 2003

(30) Foreign Application Priority Data
Dec. 20, 2002 (JP) 2002-370493

(51) Int. Cl. G10G 7/02

(52) U.S. Cl. 84/454

(57) ABSTRACT

In a tuner that measures a frequency of a tone of a musical instrument to be tuned, and displays a pitch name of the tone of the musical instrument and a difference of pitch of the pitch name from the standard pitch, thereby to tune the musical instrument, even during a time duration of measuring a frequency of the tone of the musical instrument, sampling of an electric signal corresponding to the tone of the musical instrument is carried out in succession, and a number of sample data that is required to measure the frequency are always stored in a memory of a data storage part. When the computation process for measurement of the frequency is completed, the next computation process for measurement of the frequency is started at once so that the contents of displays of a pitch name and a difference of pitch can be updated substantially at intervals of the period of a time duration of performing the computation process for measurement of the frequency.

### BACKGROUND OF THE INVENTION

1. Field of the Invention

The present invention relates to a tuner that is used in tuning a frequency of a tone generated from any one of various types of musical instruments to the proper frequency, and a data processing method suitably used in the tuner.

2. Description of the Related Art

There have been heretofore provided various types of tuners each of which measures whether a tone generated from any one of various types of musical instruments has been properly tuned to the standard pitch and displays the result of measurement on a display. For example, Japanese Utility Model Application Public Disclosure No. 07-36194 (corresponding to Utility Model Registration No. 25852259) discloses a tuner for stringed instruments, Japanese Patent Application Public Disclosure No. 06-67656 (corresponding to U.S. Pat. No. 2,681,432) discloses a tuner that can display a difference value in cent with high resolution by use of a small number of light emitting elements, Japanese Patent Application Public Disclosure No. 08-50484 (corresponding to U.S. Pat. No. 3,011,314) discloses a tuner that operates a meter display mode and/or a strobe display mode, and Japanese Utility Model Application Public Disclosure No. 06-68095 (corresponding to Utility Model Registration No. 2594264) discloses a tuner provided with a pitch display having a large number of light emitting elements disposed therein.

One example of electrical arrangements used in commercially available common tuners is show in FIG. 8. In the illustrated tuner, a tone from a musical instrument to be tuned is caught by a microphone 1 which, in turn, transduces it into an electric signal Sg. The electric signal Sg outputted from the microphone 1 is amplified by an amplifier 2 and then is supplied to a microcomputer 10. In this example, a saturated amplifier is used as the amplifier 2, and hence the input electric signal Sg is amplified in saturation by the saturated amplifier 2 into a rectangular waveform SP. For example, if the electric signal Sg has an analog waveform as shown in FIG. 9A, this analog waveform Sg is converted into a rectangular waveform SP as shown in FIG. 9B by the saturated amplifier 2.

The microcomputer 10 comprises: a sampling device 11 that acquires data at zero-crossing points b1, b2, b3, . . . of the rectangular waveform SP inputted thereto; a counter 12 that counts a clock generated at a constant rate; a data storage part 13 that stores therein sample data acquired by the sampling device 11; a fundamental period extraction part 14 that extracts the fundamental period of the rectangular waveform SP inputted thereto using the sample data stored in the data storage part 13; a pitch name determination part 15 that determines a pitch name of the input tone of the musical instrument on the basis of the fundamental period extracted by the fundamental period extraction part 14; and a difference of pitch computation part 16 that computes a difference in pitch between the standard pitch determined from the pitch name of the input tone of the musical instrument and a pitch of the input tone of the musical instrument.

The sampling device 11 is constituted by a zero-crossing detection circuit 11A that detects zero-crossing points b1, b2, b3, . . . of the rectangular waveform SP in sequence and a data latch circuit 11B that latches a time base data (a time data) at the time when the zero-crossing detection circuit 11A has detected a zero-crossing point. The rectangular waveform SP outputted from the amplifier 2 is entered into the zero-crossing detection circuit 11A.

The counter 12 counts a clock having a known frequency and repeats its operation in which the counts from the initial value “0 0 . . . 0” to the maximum value “F F . . . F” are sequentially outputted from the counter 12 with the lapse of time.

The data latch circuit 11B reads the counts C1, C2, C3, . . . of the counter 12 each time the zero-crossing detection circuit 11A sequentially detects the zero-crossing points b1, b2, b3, . . . of the rectangular waveform SP inputted thereto to latch them as sample data. FIG. 9C shows the counts (from the initial value “0 0 . . . 0” to the maximum value “F F . . . F”) of the counter 12 and the counts C1, C2, C3, . . . of the counter 12 that have been read in the data latch circuit 11B.

The sample data latched by the data latch circuit 11B are sent to the data storage part 13 in sequence and stored therein. A time interval between adjacent two zero-crossing points (between b1 and b2, b2 and b3, . . . ) can be found by obtaining a time interval between adjacent two sample data from times of the stored sample data.

The fundamental period extraction part 14 computes a time interval between adjacent two sample data from times of the sample data stored in the data storage part 13, finds a plurality of the longest time intervals that are equal to each other from the results of computations, and extracts the longest time interval as the fundamental period of the input tone of the musical instrument. In order for the fundamental period extraction part 14 to extract the fundamental period, in general, it is required that a number of time data (time base data) corresponding to at least two periods of the input tone of a musical instrument have been stored in the data storage part 13.

The pitch name determination part 15 determines a pitch name of the input tone of the musical instrument on the basis of the fundamental period extracted by the fundamental period extraction part 14, and supplies the result of determination to a pith name display 17 that is provided externally of the microcomputer 10. The difference of pitch computation part 16 computes or calculates a difference between a pitch of the tone of the musical instrument that is determined from the fundamental period extracted by the fundamental period extraction part 14 and the standard pitch that is determined from the pitch name, and supplies the result of computation to a difference of pitch display 18 provided externally of the microcomputer 10. Thus, the pitch name of the tone of the musical instrument inputted to the tuner is displayed on the pitch name display 17 and the difference of pitch from the standard pitch is displayed on the difference of pitch display 18.

Further, though not shown in FIG. 8, in the example, the pitch name determination part 15 also supplies the determined pitch name to the difference of pitch computation part 16 which, in turn, computes a difference between a pitch of the tone of the musical instrument that is determined from the fundamental period and the standard pitch that is determined from the pitch name supplied from the pitch name determination part 15.

As stated above, in the prior art tuner, the fundamental period extraction part 14 cannot extract the fundamental period of the input tone of the musical instrument unless at least a predetermined number of sample data are stored in the data storage part 13. In order to store the predetermined number of sample data in the data storage part 13, there is needed a time duration corresponding to at least two periods of the input tone of the musical instrument. Moreover, after the data have been stored in the data storage part 13, the extracting process of the fundamental period is carried out and after the fundamental period has been extracted, the determination of a pitch name and the computation of a difference of pitch are executed. As a result, there is a drawback that it takes a considerable time until the result of the determination of a pitch name and the result of the computation of a difference of pitch are displayed from the acquisition of the data.

The above-mentioned drawback will be further described with reference to FIG. 10. FIG. 10A is a timing chart showing the above-stated operation of the tuner with regard to the time base and FIG. 10B is a timing chart showing the operations of the pitch name display 17 and the difference of pitch display 18 with regard to the time base. In FIG. 10A, a time duration T1 indicates a time that is required to capture the predetermined number of time data C1, C2, C3, . . . from the rectangular waveform SP inputted to the tuner and to store them in the data storage part 13 as the sample data. A time duration T2 indicates a time that is required to extract the fundamental period in the fundamental period extraction part 14 and to determine a pitch name in the pitch name determination part 15 as well as to compute a difference of pitch from the standard pitch in the difference of pitch computation part 16. Further, in practice, the greater part of the time duration T2 is used to carry out the extracting process of the fundamental period and the time that is required to determine a pitch name and to compute a difference of pitch is a little. Accordingly, hereinafter, the time duration T2 will be referred to as fundamental period extraction time.

At the time point when the fundamental period extraction time T2 has ended, the pitch name display 17 and the difference of pitch display 18 start to display the result of the determination of pitch name and the result of the computation of difference of pitch supplied from the microcomputer 10, respectively. Simultaneously therewith, the microcomputer 10 resumes to capture the latest time data and to store them in the data storage part 13 by expenditure of the time duration T1 and to extract the fundamental period from the stored time data as well as to determine a pitch name and to compute a difference of pitch by expenditure of the time duration T2. At the time point when the fundamental period extraction time T2 has ended, the pitch name display 17 and the difference of pitch display 18 start to update their displays, respectively.

While a tone or sound is generating from the musical instrument, the above-described operation is repeated. Accordingly, in the prior art tuner, the pitch name of the tone of the musical instrument inputted to the tuner and the difference of pitch from the standard pitch are displayed on the pitch name display 17 and the difference of pitch display 18 respectively after the time duration of T1+T2 has passed. In addition, the period of updating the displays of the pitch name and the difference of pitch is also equal to the time duration of T1+T2 (=T3). In case the period T3 of updating the displays is long, if a frequency of the input tone of the musical instrument varies, there is a disadvantage that it is impossible to continuously follow the state of variation in frequency to measure it and to display the result of measurement.

For example, there is a vibrato playing as one of playings of a guitar. If a player can previously know the range of vibrations in frequency of a tone resulting from a vibrato playing, the player can learn or master a good sense of the most suitable play. That is, in case a player plays his guitar with a vibrato, if he can know the range of vibrations in frequency of that tone, it is very good for him. However, the prior art tuner cannot measure vibrations in frequency of a tone in real time and display the result of measurement in real time. In addition, even in other playings than a vibrato playing, if a tuner can measure a state that the frequency of a tone is varying in real time and display it in real time, it is very good for the player. Moreover, during a tuning of a musical instrument, if a tuner can display in real time a state that the frequency of a tone varies toward a higher or lower frequency with the tuning operation thereof, it is easy to tune the musical instrument.

In order to shorten the period of updating the display, it is necessary to shorten both the time duration T1 from the acquisition of time data to the storage of the acquired time data in the data storage part and the fundamental period extraction time T2. However, it is impossible to reduce the time duration T1 from the acquisition of time data to the storage of the acquired time data than a time duration corresponding to twice the fundamental period of a tone of a musical instrument to be tuned. On the other hand, the fundamental period extraction time T2 is determined depending upon the operation processing speed of the microcomputer 10, and there is a limit to the reduction of the fundamental period extraction time T2 even a microcomputer having higher operation processing speed is used.

### SUMMARY OF THE INVENTION

It is an object of the present invention to provide a data processing method in a tuner by which the period of updating display contents can be lessened and variation of the frequency of an input tone of a musical instrument can be displayed substantially in real time.

It is another object of the present invention to provide a tuner having a relatively simple construction, which can display variation of the frequency of an input tone of a musical instrument substantially in real time.

In order to accomplish the foregoing objects, in a first aspect of the present invention, there is provided a data processing method in a tuner comprising the steps of: (A) transducing a tone of a musical instrument to be tuned into an electric signal; (B) sampling the electric signal; (C) storing a sample data in a data storage part; (D) carrying out, when a predetermined number of sample data are stored in the data storage part, a process of extracting the fundamental period of the tone of the musical instrument using the sample data; (E) determining a pitch name of the tone of the musical instrument on the basis of the extracted fundamental period as well as computing a difference of pitch of the tone of the musical instrument from the standard pitch; (F) displaying the determined pitch name and the computed difference of pitch; (G) storing a new sample data in the data storage part during the step of carrying out a process of extracting the fundamental period and the step of determining a pitch name of the tone of the musical instrument as well as computing a difference of pitch of the tone of the musical instrument from the standard pitch; (H) carrying out, when the predetermined number of new sample data are stored in the data storage part, the process of extracting the fundamental period of the tone of the musical instrument using the new sample data; and (I) repeating the step (H) while a new sample data is being stored in the data storage part.

In a preferred embodiment, in the step (C), the sample data of the electric signal is stored in a first memory of the data storage part; the step (D) includes a step of transferring, when the predetermined number of sample data are stored in the first memory of the data storage part, these sample data to a second memory of the data storage part; the process of extracting the fundamental period in the step (D) is performed using the predetermined number of sample data stored in the second memory; in the step (G), a new sample data is stored in the first memory of the data storage part; the step (H) includes a step of transferring, when the step (E) is completed, the predetermined number of new sample data stored in the first memory to the second memory; and the process of extracting the fundamental period in the step (H) is performed using the predetermined number of new sample data stored in the second memory.

In a second aspect of the present invention, there is provided a tuner comprising: a transducer that transduces a tone of a musical instrument to be tuned into an electric signal; a sampling device that samples the electric signal; a data storage part that is capable of storing therein a predetermined number of sample data sampled by the sampling device; a fundamental period extraction part that extracts the fundamental period of the tone of the musical instrument using the predetermined number of sample data stored in the data storage part, and that immediately performs, when the extracting process of the fundamental period is completed, a process of extracting the fundamental period of the tone of the musical instrument using the predetermined number of new sample data stored in the data storage part and repeats the aforesaid operation each time the extracting process of the fundamental period is completed; a pitch name determination part that determines a pitch name of the tone of the musical instrument on the basis of the fundamental period extracted by the fundamental period extraction part; a difference of pitch computation part that computes a difference in pitch between a pitch on the basis of the fundamental period extracted by the fundamental period extraction part and the standard pitch of the determined pitch name; a pitch name display that displays the pitch name of the tone of the musical instrument determined by the pitch name determination part; a difference of pitch display that displays the difference of pitch computed by the difference of pitch computation part; and a write control part that writes sample data sampled by the sampling device in the data storage part, and that controls, during a time duration of carrying out the extracting process of the fundamental period and a time duration of determining a pitch name of the tone of the musical instrument as well as of computing a difference of pitch of the tone of the musical instrument from the standard pitch, to write a sample data newly sampled by the sampling device in the data storage part in place of the oldest sample data in the predetermined number of sample data already stored therein.

In a preferred embodiment, the data storage part comprises: a first memory that is capable of storing therein a predetermined number of sample data sampled by the sampling device; a second memory that is capable of storing therein sample data transferred from the first memory; and a data transfer part for controlling the transfer of data from the first memory to the second memory.

The fundamental period extraction part is arranged such that it carries out an operation of extracting the fundamental period of the tone of the musical instrument using the predetermined number of sample data stored in the second memory, and that controls the data transfer part to immediately transfer, when the extracting process of the fundamental period is completed, the predetermined number of new sample data stored in the first memory to the second memory.

The sampling device comprises: a zero-crossing detection circuit that detects a time point that the electric signal crosses the zero level; and a latch circuit that reads, each time the zero-crossing detection circuit detects a zero-crossing point, the count of a counter that is counting at a constant rate from the reference timing.

The write control part has a pointer storing therein an address at which is stored the oldest sample data in the predetermined number of sample data already stored in the data storage part, and controls to write the latest data in an address designated by the pointer and to shift the address of the pointer by one address.

In another preferred embodiment, the write control part performs a control for shifting all of addresses of the predetermined number of sample data already stored in the data storage part by one address, and a control for writing the latest data in an unoccupied or empty address resulting from the shifting of all addresses by one address.

The sampling device may be constituted by an analog-to-digital converter.

In still another preferred embodiment, the tuner further includes a control means for controlling, each time the sampling device samples the electric signal, to give an interrupt into the operation of the fundamental period extraction part, and to start the write control part during the interrupt time thereby to write sample data stored in the latch circuit in the data storage part.

Alternatively, each of the fundamental period extraction part, the pitch name determination part and the difference of pitch computation part may have a detection means for detecting whether the sample data stored in the latch circuit has been updated, and when it detects the fact that the sample data stored in the latch circuit has been updated during the extracting process of the fundamental period, may start the write control part thereby to write sample data stored in the latch circuit in the data storage part.

With the data processing method in a tuner according to the present invention, since the oldest sample data in the predetermined number of sample data already stored in the data storage part is eliminated and in place thereof, the latest sample data is written in the data storage part, thereby to update the contents of the predetermined number of sample data in sequence, the predetermined number of the latest sample data at each time point have always been stored in the data storage part. Accordingly, the fundamental period extraction part can immediately perform, when the process of extracting the fundamental period at present is completed, the next extracting process of the fundamental period. As a result, the extracting process of the fundamental period is carried out substantially in succession, and the result thereof can be sent at once to the pitch name determination part and the difference of pitch computation part, and hence the contents of displays can be updated at intervals of the time duration of performing the extracting process of the fundamental period. Thus, according to the present invention, the contents of displays can be updated with a period of several times that of the prior art, and accordingly, it is possible to display a varying state of the frequency of a tone of a musical instrument substantially in real time.

### BRIEF DESCRIPTION OF THE DRAWINGS

FIG. 1 is a block diagram showing the electrical arrangement of a first embodiment of the tuner according to the present invention.

FIG. 2 is a diagram showing the internal structure of the memory used in the tuner shown in FIG. 1.

FIG. 3A is a flow chart for explaining the operation of the tuner shown in FIG. 1.

FIG. 3B is a flow chart for explaining the operation of the tuner shown in FIG. 1.

FIG. 4A is a timing chart for explaining the operation of the tuner shown in FIG. 1.

FIG. 4B is a timing chart for explaining the operation of the tuner shown in FIG. 1.

FIG. 4C is a timing chart for explaining the operation of the tuner shown in FIG. 1.

FIG. 4D is a timing chart for explaining the operation of the tuner shown in FIG. 1.

FIG. 5 is a block diagram showing the essential part of a second embodiment of the tuner according to the present invention.

FIG. 6A is a flow chart for explaining the operation of a third embodiment of the tuner according to the present invention.

FIG. 6B is a flow chart for explaining the operation of a third embodiment of the tuner according to the present invention.

FIG. 7 is a block diagram showing the electrical arrangement of a fourth embodiment of the tuner according to the present invention.

FIG. 8 is a block diagram showing the electrical arrangement of a prior art tuner.

FIG. 9A is a timing chart for explaining the operation of the prior art tuner shown in FIG. 8.

FIG. 9B is a timing chart for explaining the operation of the prior art tuner shown in FIG. 8.

FIG. 9C is a timing chart for explaining the operation of the prior art tuner shown in FIG. 8.

FIG. 10A is a timing chart for explaining the operation of the prior art tuner shown in FIG. 8.

FIG. 10B is a timing chart for explaining the operation of the prior art tuner shown in FIG. 8.

### DETAILED DESCRIPTION OF THE PREFERRED EMBODIMENTS

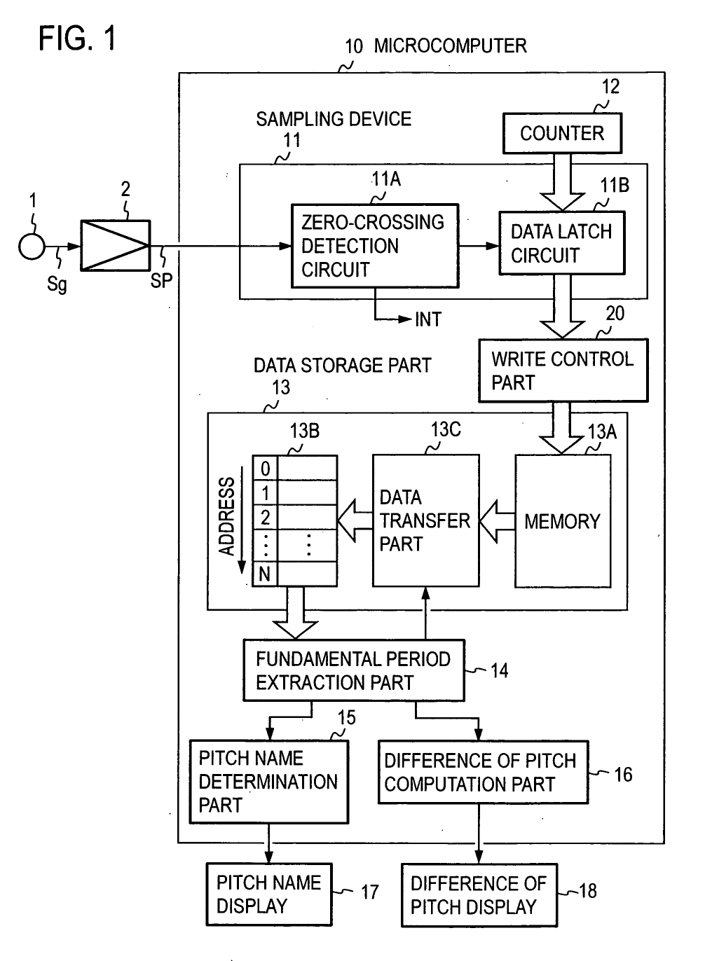

The preferred embodiments of the present invention will now be described in detail with reference to FIGS. 1 to 7. The present invention may, however, be embodied in many different forms and should not be construed as limited to the embodiments set forth hereinafter; rather, the embodiments are provided so that this disclosure will be thorough and complete, and will fully convey the scope of the invention to those skilled in the art.

First, there will be described a first embodiment of the tuner according to the present invention and a data processing method used in the tuner with reference to FIGS. 1 to 4.

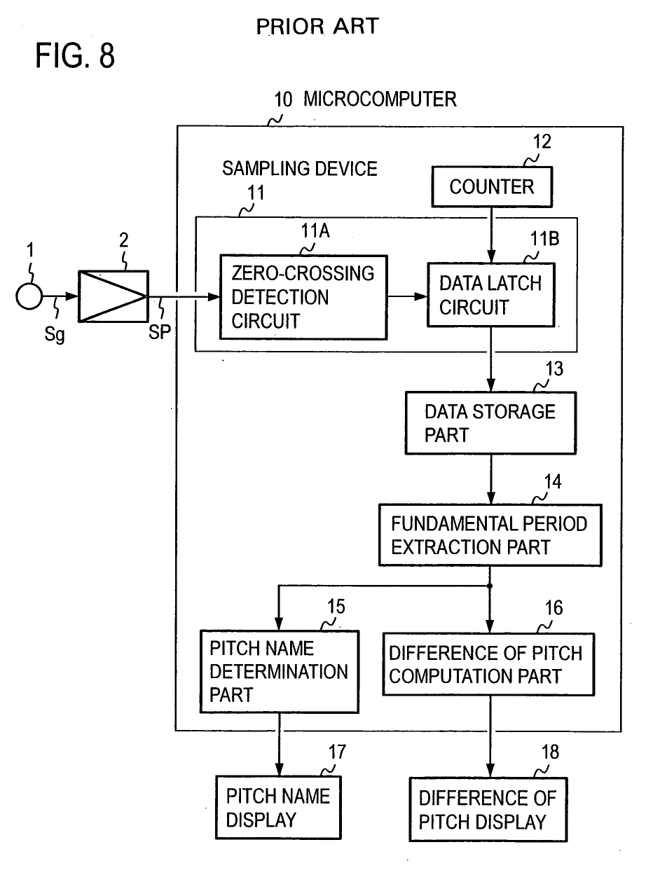

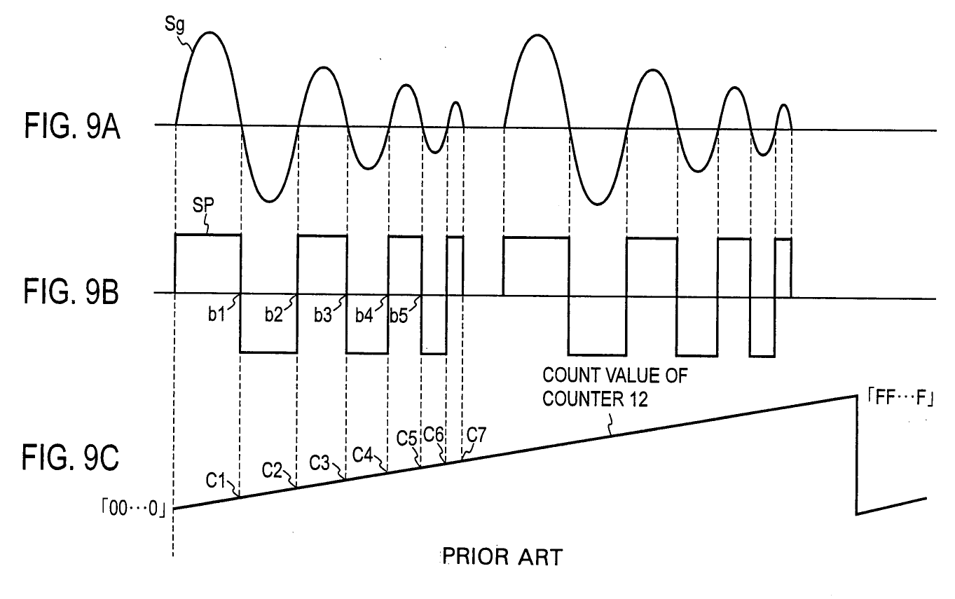

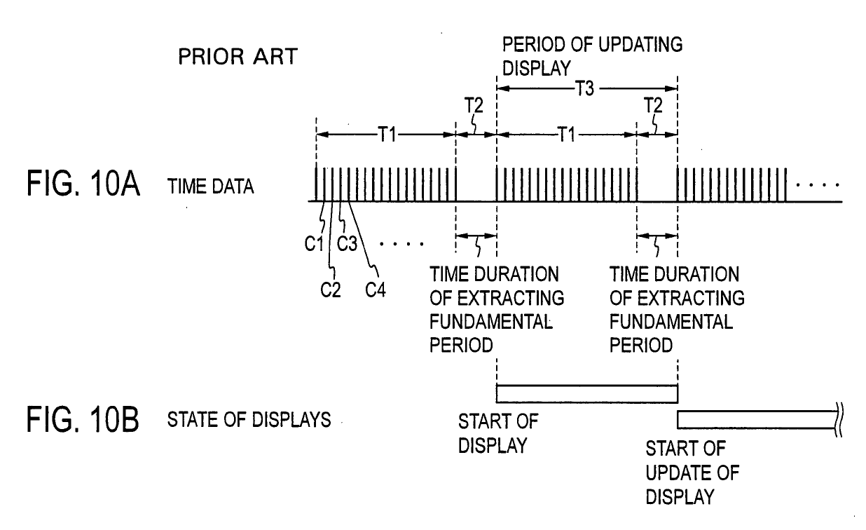

FIG. 1 is a block diagram showing the electrical arrangement of a first embodiment of the tuner according to the present invention. Further, in FIG. 1, elements and parts corresponding to those in FIG. 8 will be denoted by the same reference characters or numerals affixed thereto, and explanation thereof will be omitted unless necessary.

Likewise the prior art tuner, in the tuner of the first embodiment, a tone from a musical instrument to be tuned is captured by a microphone 1 which, in turn, transduces it into an electric signal Sg. The electric signal Sg outputted from the microphone 1 is amplified by an amplifier 2 and then is supplied to a microcomputer 10. In this first embodiment, a saturated amplifier is also used as the amplifier 2, and hence the input electric signal Sg is amplified in saturation by the saturated amplifier 2 into a rectangular waveform SP.

There may be used in the tuner of the first embodiment a sampling device 11, a counter 12, a fundamental period extraction part 14, a pitch name determination part 15 and a difference pitch computation part 16 that constitute the microcomputer 10 and that have the same arrangements or constructions as those of the prior art tuner shown in FIG. 8. Therefore, detailed explanation thereof will be omitted.

In the embodiment, a zero-crossing detection circuit 11A of the sampling device 11 is arranged such that it can generate an interrupt signal INT if necessary. In addition, time data (sample data) latched by a data latch circuit 11B of the sampling device 11 are sent to a data storage part 13 through a write control part 20. The data storage part 13 comprises a memory 13A for storing data therein, a buffer memory 13B for processing data, and a data transfer part 13C that controls transfer of data from the memory 13A to the buffer memory 13B.

The zero-crossing detection circuit 11A generates, each time it detects a zero-crossing point of the rectangular waveform SP, an interrupt signal INT in synchronism with the detection of a zero-crossing point. When an interrupt signal INT is generated from the zero-crossing circuit 11A, the microcomputer 10 starts the write control part 20. As a result, the write control part 20 executes an operation in which it writes a time data latched in the data latch circuit 11B in the memory 13A of the data storage part 13.

When a predetermined number of time data have been stored in the memory 13A, these time data are transferred to the buffer memory 13B through the data transfer part 13C. The fundamental period extraction part 14 performs a process of extracting the fundamental period by use of the time data stored in the buffer memory 13B.

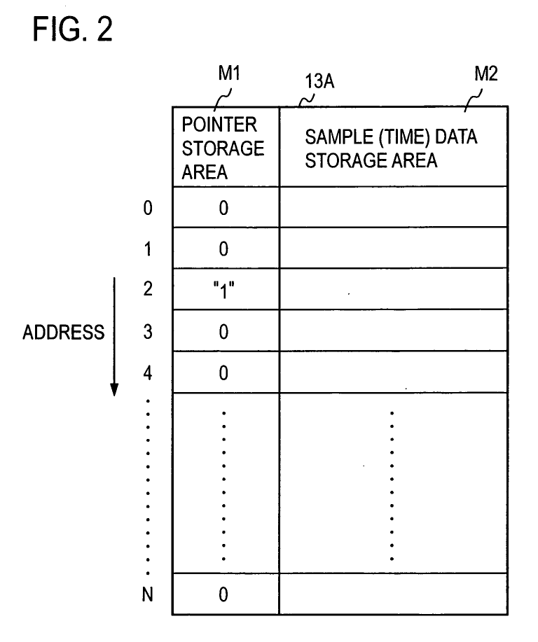

There will be described in detail with reference to FIG. 2 the operation of writing a time data in the data latch circuit 11B in the memory 13A of the data storage part 13.

FIG. 2 is a diagram showing the internal structure of the memory 13A used in the tuner shown in FIG. 1. The memory 13A has N+1 addresses from address 0 to address N, and a pointer storage area M1 and a sample (time) data storage area M2 are provided at each address. In the pointer storage area M1 is written as a pointer a data, for example, “1” that indicates an address at which a sample data should be written next time. In the example shown in FIG. 2, the data “1” is written in the pointer storage area M1 at address 2, which indicates that an address at which a sample data should be written next time is address 2.

In such condition, when an interrupt signal INT is generated from the zero-crossing detection circuit 11A so that the write control part 20 is started and a time data is read in the data latch circuit 11B from the counter 12, the write control part 20 writes the time data as a sample data in the sample data storage area M2 at address 2 indicated by the pointer (data “1”) of the memory 13A. When write of the time data has been completed, the address of the pointer is incremented by one and the data “1” is written in the pointer storage area M1 at the next address (address 3 in this example). In a similar way, the address of the pointer is incremented by one in sequence, and when the address of the pointer reaches address N, the data “1” is written in the pointer storage area M1 at the address N. When a sample data is written in the sample data storage area M2 at the address N, the address of the pointer is incremented by one. In this case, address 0 is designated as the next address and the data “1” is written in the pointer storage area M1 at the address 0. Accordingly, the address 0 is designated as an address at which a sample data should be written next time.

In this manner, in case the address at which a sample data is to be written is circulated by incrementing it by one in sequence (or by decrementing it by one in sequence), the data already stored at an address that a sample data should be written next time comes to the oldest data. Consequently, the latest sample data of N+1 have always been stored at the addresses 0 to N of the memory 13A.

In case the write operation of a sample data from the data latch circuit 11B in which a sample data is stored to the memory 13A is carried out by an interrupt, it is possible that even while the fundamental period extraction part 14 is performing the process of extracting the fundamental period, the write operation of a data in the memory 13A can be carried out in only a little time through an interrupt. Accordingly, the sample data of N+1 in the memory 13A are updated to the latest ones hour to hour. As a result, at the time point when the fundamental period extraction part 14 has performed the process of extracting the fundamental period using the sample data already stored in the buffer memory 13B and has completed the extraction of the fundamental period of a tone generated from an musical instrument, the sample data in the memory 13A have been updated to the latest ones.

When the extracting process of the fundamental period has been completed, the fundamental period extraction part 14 sends a data transfer request signal to the data transfer part 13C. As a result, the data transfer part 13C transfers the latest sample data stored in the memory 13A to the buffer memory 13B.

At the same time, the fundamental period extraction part 14 sends the extracted fundamental period data to both the pitch name determination part 15 and the difference of pitch computation part 16. The pitch name determination part 15 determines a pitch name of the tone of the musical instrument on the basis of the fundamental period data inputted thereto, and supplies the result of determination to a pith name display 17 that is provided externally of the microcomputer 10. Though not shown in FIG. 1, the pitch name determination part 15 also gives the determined pitch name to the difference of pitch computation part 16. The difference of pitch computation part 16 computes a difference between a pitch of the tone of the musical instrument that is determined from the input fundamental period data and the standard pitch that is determined from the pitch name given from the pitch name determination part 15, and supplies the result of computation to a difference of pitch display 18 provided externally of the microcomputer 10. Thus, the pitch name of the tone of the musical instrument inputted to the tuner is displayed on the pitch name display 17 and the difference of pitch from the standard pitch is displayed on the difference of pitch display 18.

As discussed above, in case the write operation of a sample data from the data latch circuit 11B to the memory 13A is carried out by an interrupt, except a time duration from the initial state until a predetermined number of sample data (the number of sample data that enable the tuner to extract the fundamental period of a tone of a musical instrument, for example, N+1) are stored in the memory 13A, the fundamental period extraction part 14 can perform immediately, each time the process of extracting the fundamental period (including the processes of determining a pitch name and of computing a difference of pitch) is completed, the next extracting process of the fundamental period using the updated sample data, after the predetermined number of sample data have been stored in the buffer memory 13B. Accordingly, to both the displays 17 and 18 are always given the latest result of determination of a pitch name and the latest result of computation of a difference of pitch at high speed with the period of the fundamental period extraction time T2. As compared with the prior art, the time duration T1 does not exist between updates of displays, and hence the contents of display can be updated at a repetitive rate of several times that of the prior art. As a result, as the frequency of the input tone of the musical instrument varies, it is possible to display the varying state of the frequency on the difference of pitch display 18 in real time.

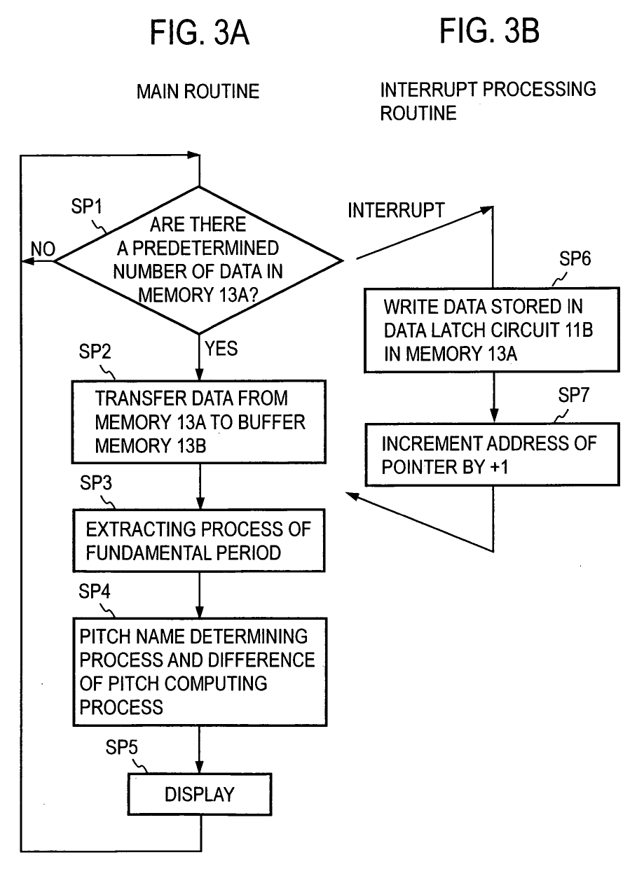

Now, the operation of the tuner constructed as discussed above will be described with reference to FIG. 3.

FIG. 3A is a flow chart showing a main routine in the program for operating the tuner constructed as discussed above and FIG. 3B is a flow chart showing an interrupt processing routine in the program. The main routine shown in FIG. 3A controls the data storage part 13, the fundamental period extraction part 14, the pitch name determination part 15, the difference of pitch computation part 16, the pitch name display 17 and the difference of pitch display 18. On the other hand, the interrupt processing routine shown in FIG. 3B is executed in case the zero-crossing detection circuit 11A detects a zero-crossing point during the execution of the main routine and generates an interrupt signal INT.

At first, in a first step SP1 of the main routine, it is determined whether a predetermined number of sample data are stored in the memory 13A or not. In case the predetermined number of sample data has not been stored (NO), the first step SP1 is repeated. In case the predetermined number of sample data has been stored (YES), the program proceeds to a second step SP2.

In the second step SP2, the sample data are transferred to the buffer memory 13B from the memory 13A. In case of transfer of the sample data, the data transfer part 13C transfers, at first, the sample data from an address at which the data “1” has been written in the pointer storage area M1 of the memory 13A to the address N to the buffer memory 13B, and subsequently thereto, transfers the sample data from the address 0 to one address before the address at which the data “1” has been written in the pointer storage area M1 to the buffer memory 13B.

The buffer memory 13B determines the first transferred sample data to be the oldest data and stores this data in the sample data storage area M2, for example, at the address N. The buffer memory 13B stores the subsequent transferred sample data in the sample data storage area M2 at the addresses N−1, N−2, . . . , 0 in sequence, thereby to rearrange the sample data. Such rearrangement of the sample data results in a descending order or ascending order (descending order in this example) of data acquisition times in sequence of addresses (from address 0 toward address N), and accordingly, it is easy to carry out the process of extracting the fundamental period.

When the transfer of the sample data in the second step SP2 has been completed, the program proceeds to a third step SP3 in which the fundamental period extraction part 14 performs the process of extracting the fundamental period using the sample data stored in the buffer memory 13B. When the fundamental period has been extracted, the program proceeds to a fourth step SP4.

In the fourth step SP4, the pitch name determination part 15 determines a pitch name of the input tone using the fundamental period extracted in the third step SP3, and simultaneously therewith, the difference of pitch computation part 16 computes a difference (an error in pitch) between a pitch of the input tone that is determined from the fundamental period extracted in the third step SP3 and the standard pitch that is determined from the pitch name determined by the pitch name determination part 15. When the pitch name has been determined and the difference of pitch has been computed, the program proceeds to a fifth step SP5.

In the fifth step SP5, the pitch name determined in the fourth step SP4 is inputted to the difference of pitch display 18 and the difference of pitch is inputted to the difference of pitch display 18 so that they are displayed on the pitch name display 17 and the difference of pitch display 18, respectively. When the pitch name and the difference of pitch have been displayed on the displays 17 and 18 respectively, the program returns back to the first step SP1, and the aforesaid operations from the first step SP1 to the fifth step SP5 are repeated. Further, displays on the displays 17 and 18 on and after the second time correspond to updates of the display contents on the displays 17 and 18.

When the zero-crossing detection circuit 11A detects a zero-crossing point during the execution of the main routine, it generates an interrupt signal INT. On generation of the interrupt signal INT, in a step SP6 of the interrupt processing routine, the write control part 20 starts and writes a sample data stored in the data latch circuit 11B in the memory 13A. When the write of a sample data has been completed, the interrupt processing routine proceeds to a step SP7 in which the address of the pointer of the memory 13A is incremented (or decremented) by one, and thereafter, the interrupt processing routine returns to the main routine shown in FIG. 3A. Each time the zero-crossing detection circuit 11A detects a zero-crossing point during the execution of the main routine, the above-mentioned interrupt processing routine is carried out.

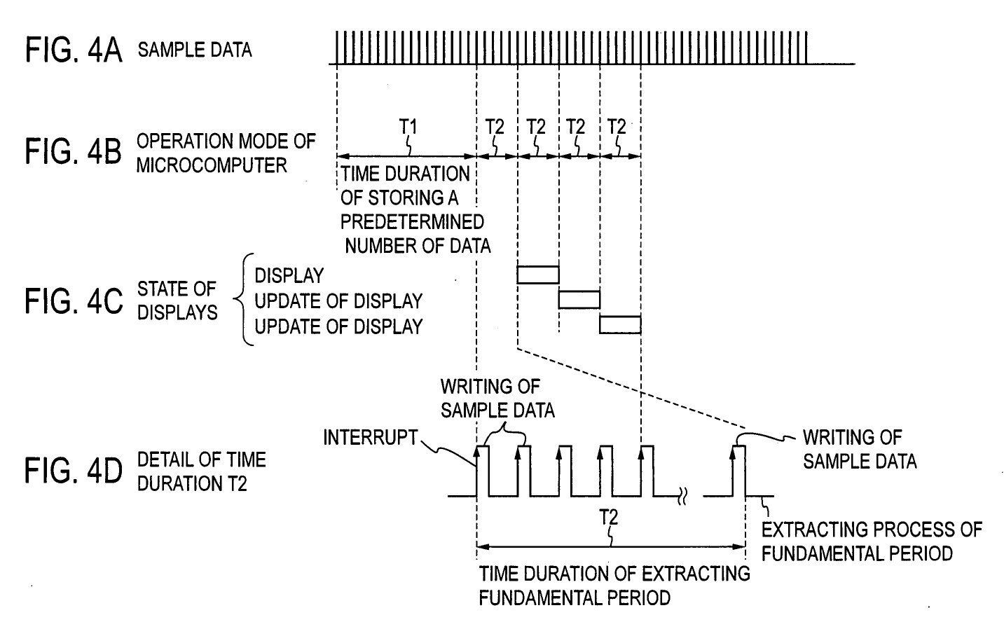

FIG. 4 is timing charts showing the operation of the tuner of the first embodiment with regard to the time base, and FIG. 4A shows sample data latched in the data latch circuit 11B, FIG. 4B shows the operation mode of the microcomputer 10, FIG. 4C shows the operation modes of the pitch name display 17 and the difference of pitch display 18 and FIG. 4D shows the interrupt processing operation.

In FIG. 4A, a time duration T1 indicates a time that is required to acquire the predetermined number of time data C1, C2, C3, . . . from the rectangular waveform SP inputted to the tuner and to store them in the memory 13A of the data storage part 13 as the sample data. Time duration T2 indicates a time that is required to extract the fundamental period in the fundamental period extraction part 14 and to determine a pitch name in the pitch name determination part 15 as well as to compute a difference of pitch from the standard pitch in the difference of pitch computation part 16. Further, in practice, the greater part of the time duration T2 is used to carry out the extracting process of the fundamental period and the time that is required to determine a pitch name and to compute a difference of pitch is a little. Accordingly, hereinafter, the time duration T2 will be referred to as fundamental period extraction time.

As is easily understood from FIG. 4, in case the above-stated data processing method according to the present invention is used, the time duration T1 from the initial state until the predetermined number of sample data have been stored in the memory 13A is equal to that of the prior art, but once the predetermined number of (for example, N+1) sample data have been stored in the buffer memory 13B, on and after that time, the fundamental period extraction part 14 can immediately perform, each time the process of extracting the fundamental period (including the processes of determining a pitch name and of computing a difference of pitch) is completed, the next extracting process of the fundamental period using the updated sample data. In other words, the extracting process of the fundamental period in the fundamental period extraction part 14 is carried out substantially in succession without interruption. Accordingly, to both the displays 17 and 18 are always given the latest result of determination of a pitch name and the latest result of computation of a difference of pitch at intervals of the fundamental period extraction time T2. This means that the contents of displays on both the displays can be updated without need of the time duration T1 that is much longer than the fundamental period extraction time T2. As a result, there is obtained a remarkable advantage that as compared with the prior art, the contents of displays can be updated at a repetitive rate of several times that of the prior art. Therefore, as the frequency of the input tone of the musical instrument varies, it is possible to display the varying state of the frequency on the difference of pitch display 18 in real time.

In the first embodiment, there have been described the tuner and the data processing method arranged such that the pointer storage areas M1 are provided in the memory 13A and the next sample data is written at an address designated by the pointer so that the latest sample data is written at an address of the oldest sample data among the sample data already stored in the memory 13A thereby to always update the N+1 sample data to the latest ones. However, the present invention is not limited to the tuner and the data processing method described above.

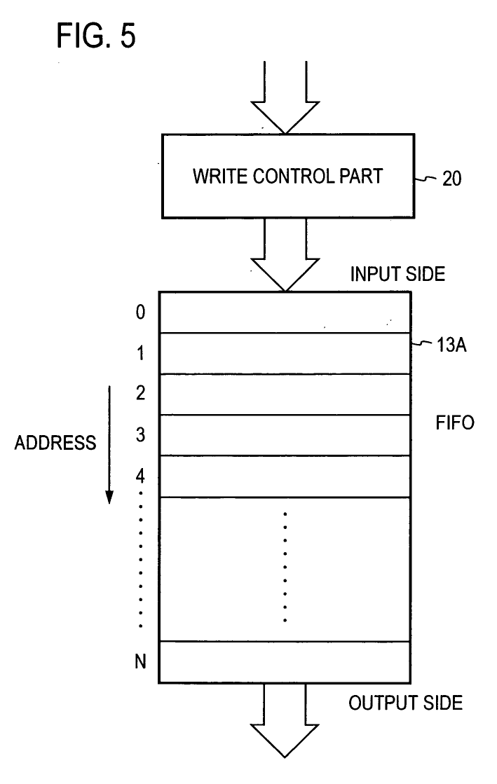

FIG. 5 is a block diagram showing the essential part of a second embodiment of the tuner according to the present invention in which a memory called FIFO (first-in first-out) in this technical field is used as the memory 13A of the data storage part 13. Other elements and parts are the same as those in the first embodiment shown in FIG. 1, and explanation thereof will be omitted.

In case a FIFO memory is used, the first sample data to be written through the write control part 20 is stored in the first or top address 0 at the input side of the memory 13A in this embodiment. When the next sample data is written in the first address 0, the sample data already stored in the first address 0 is shifted to the next address 1. In the same manner, each time a sample data is written in the first address 0, the sample data already stored are shifted by one address toward the address N at the output side of the memory 13A. In the state that the oldest sample data reaches the last address N at the output side, when the next sample data is written in the first address 0, the sample data already stored in the address N is discharged to the outside and is eliminated from the memory 13A. Accordingly, the latest sample data is always written in the first address 0 at the input side.

In case a FIFO memory has been used, the write control part 20 merely control to increment or decrement by one the address or addresses of sample data already written in the memory 13A thereby to shift the sample data by one address as well as to control to write the latest sample data in the first address 0 at the input side. In addition, in the buffer memory 13B, there is no need to rearrange sample data transferred from the memory 13A.

In such way, in case a FIFO memory is used as the memory 13A, it is possible to update the N+1 sample data in the memory 13A to the latest ones without designating an address at which the next sample data is to be written by the pointer. As a result, at the time point when the fundamental period extraction part 14 performs the process of extracting the fundamental period using the sample data already stored in the buffer memory 13B and is completed the extraction of the fundamental period of a tone of the musical instrument, the sample data stored in the memory 13A are updated to the latest ones. Accordingly, in the second embodiment, it is clear that the same data processing as that in the first embodiment can be done and the same function and effects as those in the first embodiment can be obtained, and explanation thereof will be omitted.

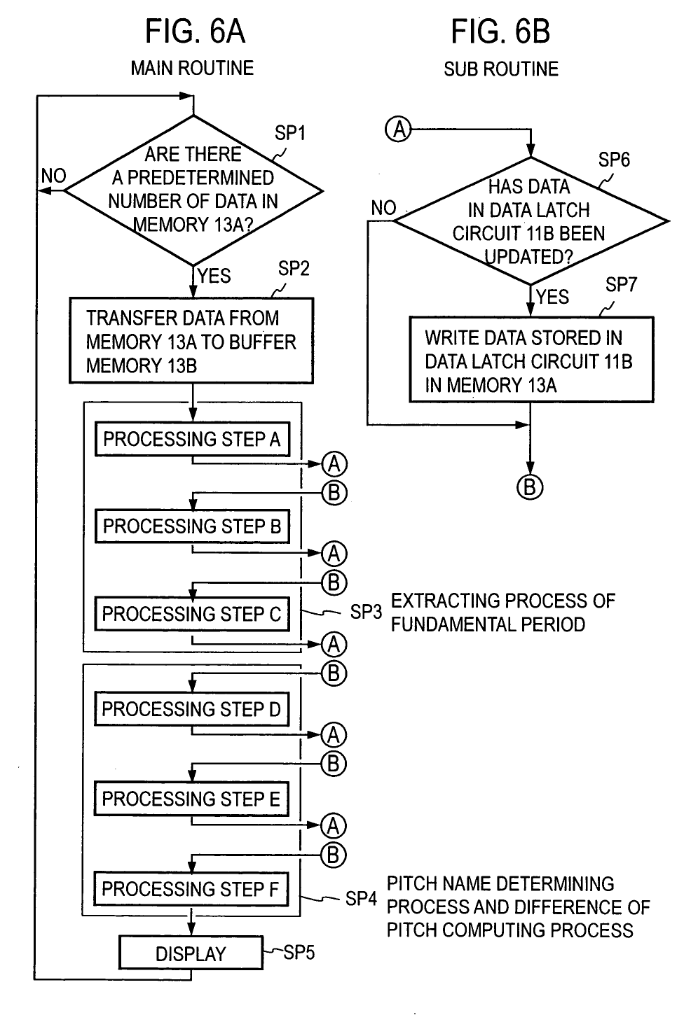

FIG. 6 is flow charts for explaining the operation of a third embodiment of the tuner according to the present invention, and FIG. 6A shows a main routine in the program for operating the tuner of the third embodiment, and FIG. 6B shows a sub routine executed in steps SP3 and SP4 of the main routine.

At first, in a first step SP1 of the main routine, it is determined whether a predetermined number of sample data are stored in the memory 13A or not. In case the predetermined number of sample data has not been stored (NO), the first step SP1 is repeated. In case the predetermined number of sample data has been stored (YES), the program proceeds to a second step SP2.

In the second step SP2, the sample data are transferred to the buffer memory 13B from the memory 13A. In case of transferring the sample data, the data transfer part 13C transfers, if the memory 13A shown in FIG. 2 is used, the sample data from an address at which the data “1” has been written in the pointer storage area M1 of the memory 13A to the address N to the buffer memory 13B, and subsequently thereto, transfers the sample data from the address 0 to one address before the address at which the data “1” has been written in the pointer storage area M1 to the buffer memory 13B.

On the other hand, if the FIFO memory 13A shown in FIG. 5 is used, the data transfer part 13C transfers the N+1 sample data from the sample data at the address N to the sample data at the address 0 to the buffer memory 13B from the sample data at the address N until the sample data at the address 0 in sequence.

When the transfer of the sample data in the second step SP2 has been completed, the program proceeds to the third step SP3 in which the fundamental period extraction part 14 performs the process of extracting the fundamental period using the sample data stored in the buffer memory 13B. When the fundamental period has been extracted, the program proceeds to the fourth step SP4.

In the fourth step SP4, the pitch name determination part 15 determines a pitch name of the input tone using the fundamental period extracted in the third step SP3, and simultaneously therewith, the difference of pitch computation part 16 computes a difference (an error in pitch) between a pitch of the input tone that is determined from the fundamental period extracted in the third step SP3 and the standard pitch that is determined from the pitch name determined by the pitch name determination part 15. When the pitch name has been determined and the difference of pitch has been computed, the program proceeds to a fifth step SP5.

In the fifth step SP5, the pitch name determined in the fourth step SP4 is inputted to the difference of pitch display 18 and the difference of pitch is inputted to the difference of pitch display 18 so that they are displayed on the pitch name display 17 and the difference of pitch display 18, respectively. When the pitch name and the difference of pitch have been displayed on the displays 17 and 18 respectively, the program returns back to the first step SP1, and the aforesaid operations from the first step SP1 to the fifth step SP5 are repeated. Further, displays on the displays 17 and 18 on and after the second time correspond to updates of the display contents on the displays 17 and 18.

In the third embodiment, the third step SP3 is divided into a plurality of processing steps A, B and C, and each time each of the processing steps A, B and C has been completed, the sub routine shown in FIG. 6B is executed. Moreover, the fourth step SP4 is also divided into a plurality of processing steps D, E and F, and each time each of the processing steps D, E and F has been completed, the sub routine shown in FIG. 6B is executed.

First, when the processing step A has been ended, the program proceeds to a decision block SP6 of the sub routine. In the decision block SP6, it is determined whether the data in the data latch circuit 11B is updated or not. In case the data in the data latch circuit 11B has not been updated (NO), the program proceeds to the processing step B of the main routine, and in case the data in the data latch circuit 11B has been updated (YES), the program proceeds to the next step SP7 of the sub routine. In the step SP7, the updated sample data latched in the data latch circuit 11B is written in the memory 13A. Thereafter, the program proceeds to the processing step B of the main routine.

When each of the processing steps B and C has been completed, the sub routine shown in FIG. 6B is executed like in the same manner as processing step A. After the processing step C has been ended and subsequently thereto, the above-stated sub routine has been carried out, the program proceeds to the processing step D of the fourth step SP4 of the main routine.

When each of the processing steps D and E of the fourth step SP4 has been ended, the sub routine shown in FIG. 6B is executed. When the processing step F has been completed, the program proceeds to the fifth step SP5.

The tuner of the third embodiment is arranged such that the sample data stored in the memory 13A are updated during the fundamental period extraction time T2 without generating any interrupt signal from the zero-crossing detection circuit 11A of the sampling device 11. Accordingly, in FIG. 6A, though each of the third step SP3 and the fourth step SP4 is divided into three processing steps, in practice, it is required that the sub routine shown in FIG. 6B is carried out by the number of times by which at least the predetermined number of updated sample data (the number of updated sample data that enables the tuner to extract the fundamental period of a tone of the musical instrument) can be written in the memory 13A. Therefore, the total number of divisions of the steps SP3 and SP4 is at least the predetermined number plus one. As already described, since the third step SP3 occupies the greater part of the fundamental period extraction time T2, the number of divisions of the third step SP3 is much larger than that of the fourth step SP4.

With the construction as discussed above, though the third and the fourth steps SP3 and SP4 are divided into a plurality of processing steps respectively, an instruction for carrying out the sub routine shown in FIG. 6B is merely issued when each of the processing steps (except for the last processing step of the fourth step SP4) has been completed, and so an interrupted time between the processing steps is a very little. Accordingly, it is possible to update the sample data stored in the memory 13A without substantially lengthening the fundamental period extraction time T2. The fundamental period extraction part 14 can perform immediately, each time the process of extracting the fundamental period (including the processes of determining a pitch name and of computing a difference of pitch) is completed, the next extracting process of the fundamental period using the updated sample data. In other words, since the extracting process of the fundamental period in the fundamental period extraction part 14 is carried out substantially in succession without interruption, the latest result of determination of a pitch name and the latest result of computation of a difference of pitch are always given to both the displays 17 and 18 at high speed with the period of the fundamental period extraction time T2. Thus, in the third embodiment, the same function and effects as those in the first and the second embodiments can be obtained.

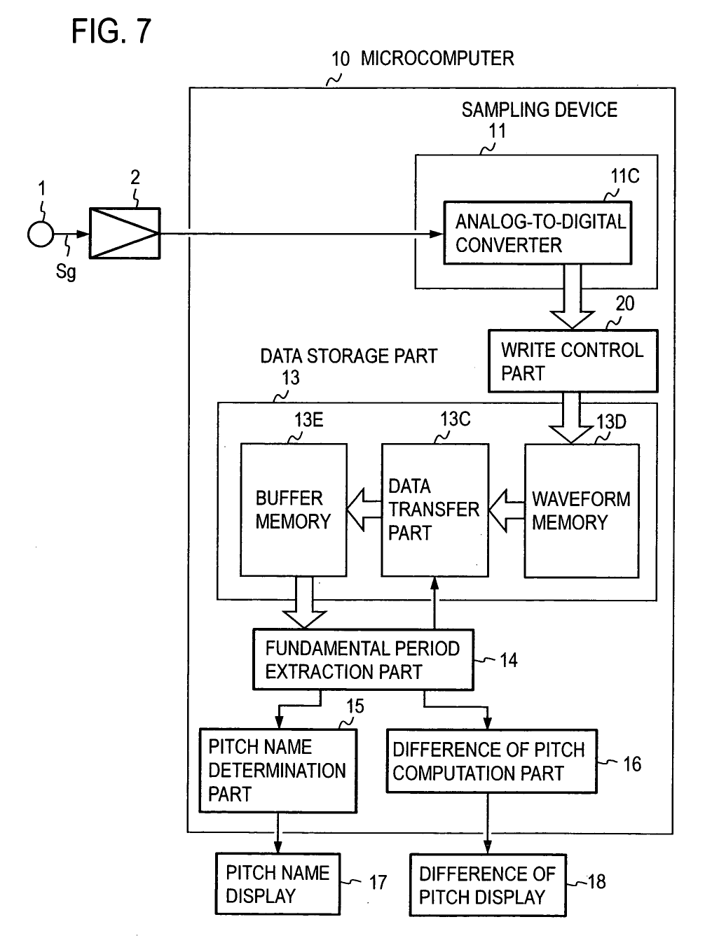

FIG. 7 is a block diagram showing the electrical arrangement of a fourth embodiment of the tuner according to the present invention. In FIG. 7, elements and parts corresponding to those in FIG. 1 will be denoted by the same reference characters or numerals affixed thereto, and explanation thereof will be omitted unless necessary.

In this fourth embodiment, the sampling device 11 is constituted by an analog-to-digital converter 11C. Accordingly, as the amplifier 2 that amplifies an electric signal Sg outputted from the microphone 1, a linear amplifier is used in the embodiment. The linear amplifier 2 amplifies an electric signal (a tone of a musical instrument) Sg inputted thereto without causing any distortion to supply the amplified signal to the analog-to-digital converter 11C which, in turn, converts the input electric signal to a digital signal. The waveform data of the digital signal are stored through the write control part 20 in a waveform memory 13D that is one component of the data storage part 13. When a predetermined number of waveform data (the number of waveform data that enables the tuner to extract the fundamental period of a tone of a musical instrument) have been stored in the waveform memory 13D, these waveform data are transferred to the buffer memory 13E through the data transfer part 13C.

The fundamental period extraction part 14 extracts the fundamental period by use of the predetermined number of the waveform data stored in the buffer memory 13E. The fundamental period extraction part 14 compares, for example, the waveform data of one period with the waveform data of the subsequent one period in the predetermined number of the waveform data by shifting the phase of the waveform data of either one period, and detects an amount of phase shift that is needed until the waveform of the one period coincides with the waveform of the subsequent one period. It detects one wavelength of the waveform from the amount of phase shift and extracts the fundamental period of the signal from the one wavelength of the waveform.

While the fundamental period extraction part 14 is executing the process of extracting the fundamental period, the analog-to-digital converter 11C converts an analog waveform of an electric signal inputted thereto in succession to a digital signal, and a waveform of the digital signal is stored in the waveform memory 13D through the write control part 20. Accordingly, the waveform data (sample data) stored in the waveform memory 13D are updated to the latest ones every moment. As a result, at the time point when the fundamental period extraction part 14 performs the process of extracting the fundamental period using the waveform data already stored in the buffer memory 13E and is completed the extraction of the fundamental period of a tone of the musical instrument, the waveform data stored in the waveform memory 13D are updated to the latest ones.

When the extracting process of the fundamental period has been completed, the fundamental period extraction part 14 sends a data transfer request signal to the data transfer part 13C. As a result, the data transfer part 13C transfers the latest waveform data stored in the waveform memory 13D to the buffer memory 13E. The fundamental period extraction part 14 again carries out the extracting process of the fundamental period in the same manner as described above, thereby to extract the fundamental period of the signal using the latest waveform data.

At the same time, the fundamental period extraction part 14 sends the extracted fundamental period data to both the pitch name determination part 15 and the difference of pitch computation part 16. The pitch name determination part 15 determines a pitch name of the tone of the musical instrument on the basis of the fundamental period data inputted thereto, and supplies the result of determination to a pith name display 17 that is provided externally of the microcomputer 10. Though not shown in FIG. 7, the pitch name determination part 15 also gives the determined pitch name to the difference of pitch computation part 16. The difference of pitch computation part 16 computes a difference between a pitch of the tone of the musical instrument that is determined from the input fundamental period data and the standard pitch that is determined from the pitch name given from the pitch name determination part 15, and supplies the result of computation to a difference of pitch display 18 provided externally of the microcomputer 10. Thus, the pitch name of the tone of the musical instrument inputted to the tuner is displayed on the pitch name display 17 and the difference of pitch from the standard pitch is displayed on the difference of pitch display 18.

As discussed above, in the fourth embodiment, except a time duration from the initial state until a predetermined number of waveform data (the number of waveform data that enable the tuner to extract the fundamental period of a tone of a musical instrument) are stored in the waveform memory 13D, on and after the predetermined number of waveform data have been stored in the buffer memory 13E, the fundamental period extraction part 14 can immediately perform, each time the process of extracting the fundamental period (including the processes of determining a pitch name and of computing a difference of pitch) is completed, the next extracting process of the fundamental period using the updated waveform data. In other words, since the extracting process of the fundamental period in the fundamental period extraction part 14 is carried out substantially in succession without interruption, the latest result of determination of a pitch name and the latest result of computation of a difference of pitch are always given to both the displays 17 and 18 at high speed with the period of the fundamental period extraction time T2. As a result, as compared with the prior art, the pitch name display 17 and the difference of pitch display 18 are both updated in their contents of displays at a repetitive rate of several times that of the prior art. Accordingly, as the frequency of the input tone of the musical instrument varies, it is possible to display the varying state of the frequency on the difference of pitch display 18 in real time.

As is apparent from the foregoing description, according to the present invention, it is constructed that even during the time duration of carrying out the process of extracting the fundamental period of a tone of a musical instrument extraction time, a sample data is detected and stored in the memory of the data storage part. Therefore, at the time point when the process of extracting the fundamental period has been completed, the latest sample data have always been stored in the memory, and the fundamental period extraction part can immediately perform, each time the extracting process of the fundamental period has been completed, the next extracting process of the fundamental period using the latest sample data as well as can output the result of determination of a pitch name and the result of computation of a difference of pitch at intervals of the period of the fundamental period extraction time duration in the fundamental period extraction part. Consequently, the contents of displays on both the displays can be updated at intervals of the period of the fundamental period extraction time duration, and during a tuning of a musical instrument, if the frequency of a tone of the musical instrument varies, it is possible to display the varying state of the frequency on the display in real time.

As a result, in case a player plays his guitar with a vibrato, for example, the player can previously know the range of vibrations in frequency of a tone resulting from a vibrato playing, and can master a good sense of the most suitable play. In addition, even in other playings than a vibrato playing, it is possible to measure and display a state that the frequency of a tone is varying in real time. Moreover, during a tuning of a musical instrument, since it is possible to display a state that the frequency of a tone generated from the musical instrument varies toward a higher or lower frequency with the tuning operation thereof, it is easy to tune the musical instrument.

Further, in each of the embodiments, there are provided in the data storage part two memories, one being a memory in which sample data are written from the sampling device and the other being a buffer memory for storing therein the sample data transferred from the one memory through the data transfer part. However, if there is used such arrangement that a predetermined number of sample data are read in the fundamental period extraction part and the fundamental period extraction part carries out the extracting process of the fundamental period using the sample data read therein, the data storage part may have only one memory provided therein in which sample data are written from the sampling device.

While the present invention has been described with regard to the preferred embodiments shown by way of example, it will be apparent to those skilled in the art that various modifications, alterations, changes, and/or minor improvements of the embodiments described above can be made without departing from the spirit and the scope of the present invention. Accordingly, it should be understood that the present invention is not limited to the illustrated embodiments, and is intended to encompass all such modifications, alterations, changes, and/or minor improvements falling within the scope of the invention defined by the appended claims.

What is claimed is:

1. A data processing method in a tuner comprising the steps of:
(A) transducing a tone of a musical instrument to be tuned into an electric signal;
(B) sampling the electric signal;
(C) storing a sample data in a data storage part;
(D) carrying out, when a predetermined number of sample data are stored in said data storage part, a process of extracting the fundamental period of the tone of the musical instrument using the sample data;
(E) determining a pitch name of the tone of the musical instrument on the basis of the extracted fundamental period as well as computing a difference of pitch of the tone of the musical instrument from the standard pitch;
(F) displaying the determined pitch name and the computed difference of pitch;
(G) storing a new sample data in the data storage part during the step of carrying out a process of extracting the fundamental period and the step of determining a pitch name of the tone of the musical instrument as well as computing a difference of pitch of the tone of the musical instrument from the standard pitch;
(H) carrying out, when the predetermined number of new sample data are stored in the data storage part, the process of extracting the fundamental period of the tone of the musical instrument using the new sample data; and
(I) repeating the step (H) while a new sample data is being stored in the data storage part.

2. The method as set forth in claim 1, wherein
in the step (C), the sample data of the electric signal is stored in a first memory of the data storage part;
the step (D) includes a step of transferring, when the predetermined number of sample data are stored in the first memory of the data storage part, these sample data to a second memory of the data storage part;
the process of extracting the fundamental period in the step (D) is performed using the predetermined number of sample data stored in the second memory;
in the step (G), a new sample data is stored in the first memory of the data storage part;
the step (H) includes a step of transferring, when the step (E) is completed, the predetermined number of new sample data stored in the first memory to the second memory; and
the process of extracting the fundamental period in the step (H) is performed using the predetermined number of new sample data stored in the second memory.

3. A tuner comprising:
a transducer that transduces a tone of a musical instrument to be tuned into an electric signal;
a sampling device that samples the electric signal;
a data storage part that is capable of storing therein a predetermined number of sample data sampled by said sampling device;
a fundamental period extraction part that extracts the fundamental period of the tone of the musical instrument using the predetermined number of sample data stored in said data storage part, and that immediately performs, when the extracting process of the fundamental period is completed, a process of extracting the fundamental period of the tone of the musical instrument using the predetermined number of new sample data stored in the data storage part and repeats the aforesaid operation each time the extracting process of the fundamental period is completed;
a pitch name determination part that determines a pitch name of the tone of the musical instrument on the basis of the fundamental period extracted by said fundamental period extraction part;
a difference of pitch computation part that computes a difference in pitch between a pitch on the basis of the fundamental period extracted by the fundamental period extraction part and the standard pitch of the determined pitch name;
a pitch name display that displays the pitch name of the tone of the musical instrument determined by said pitch name determination part;
a difference of pitch display that displays the difference of pitch computed by said difference of pitch computation part; and
a write control part that writes sample data sampled by the sampling device in the data storage part, and that controls, during a time duration of carrying out the extracting process of the fundamental period and a time duration of determining a pitch name of the tone of the musical instrument as well as of computing a difference of pitch of the tone of the musical instrument from the standard pitch, to write a sample data newly sampled by the sampling device in the data storage part in place of the oldest sample data in the predetermined number of sample data already stored therein.

4. The tuner as set forth in claim 3, wherein
the data storage part comprises: a first memory that is capable of storing therein a predetermined number of sample data sampled by the sampling device; a second memory that is capable of storing therein sample data transferred from said first memory; and a data transfer part for controlling the transfer of data from the first memory to the second memory, and
the fundamental period extraction part is arranged such that it carries out an operation of extracting the fundamental period of the tone of the musical instrument using the predetermined number of sample data stored in the second memory, and that controls the data transfer part to immediately transfer, when the extracting process of the fundamental period is completed, the predetermined number of new sample data stored in the first memory to the second memory.

5. The tuner as set forth in claim 3, wherein
the sampling device comprises: a zero-crossing detection circuit that detects a time point that the electric signal crosses the zero level; and a latch circuit that reads, each time the zero-crossing detection circuit detects a zero-crossing point, the count of a counter that is counting at a constant rate from the reference timing.

6. The tuner as set forth in claim 4, wherein
the sampling device comprises: a zero-crossing detection circuit that detects a time point that the electric signal crosses the zero level; and a latch circuit that reads, each time the zero-crossing detection circuit detects a zero-crossing point, the count of a counter that is counting at a constant rate from the reference timing.

7. The tuner as set forth in claim 3, wherein
the sampling device is constituted by an analog-to-digital converter.

8. The tuner as set forth in claim 4, wherein
the sampling device is constituted by an analog-to-digital converter.

9. The tuner as set forth in claim 3, wherein
the write control part has a pointer storing therein an address at which is stored the oldest sample data in the predetermined number of sample data already stored in the data storage part, and controls to write the latest data in an address designated by the pointer and to shift the address of the pointer by one address.

10. The tuner as set forth in claim 4, wherein
the write control part has a pointer storing therein an address at which is stored the oldest sample data in the predetermined number of sample data already stored in the data storage part, and controls to write the latest data in an address designated by the pointer and to shift the address of the pointer by one address.

11. The tuner as set forth in claim 5, wherein
the write control part has a pointer storing therein an address at which is stored the oldest sample data in the predetermined number of sample data already stored in the data storage part, and controls to write the latest data in an address designated by the pointer and to shift the address of the pointer by one address.

12. The tuner as set forth in claim 6, wherein
the write control part has a pointer storing therein an address at which is stored the oldest sample data in the predetermined number of sample data already stored in the data storage part, and controls to write the latest data in an address designated by the pointer and to shift the address of the pointer by one address.

13. The tuner as set forth in claim 3, wherein
the write control part performs a control for shifting all of addresses of the predetermined number of sample data already stored in the data storage part by one address, and a control for writing the latest data in an unoccupied or empty address resulting from the shifting of all addresses by one address.

14. The tuner as set forth in claim 4, wherein
the write control part performs a control for shifting all of addresses of the predetermined number of sample data already stored in the data storage part by one address, and a control for writing the latest data in an unoccupied or empty address resulting from the shifting of all addresses by one address.

15. The tuner as set forth in claim 5, wherein
the write control part performs a control for shifting all of addresses of the predetermined number of sample data already stored in the data storage part by one address, and a control for writing the latest data in an unoccupied or empty address resulting from the shifting of all addresses by one address.

16. The tuner as set forth in claim 6, wherein
the write control part performs a control for shifting all of addresses of the predetermined number of sample data already stored in the data storage part by one address, and a control for writing the latest data in an unoccupied or empty address resulting from the shifting of all addresses by one address.

17. The tuner as set forth in claim 5, further including:
a control means for controlling, each time the sampling device samples the electric signal, to give an interrupt into the operation of the fundamental period extraction part, and to start the write control part during the interrupt time thereby to write sample data stored in the latch circuit in the data storage part.

18. The tuner as set forth in claim 6, further including:
a control means for controlling, each time the sampling device samples the electric signal, to give an interrupt into the operation of the fundamental period extraction part, and to start the write control part during the interrupt time thereby to write sample data stored in the latch circuit in the data storage part.

19. The tuner as set forth in claim 5, wherein
each of the fundamental period extraction part, the pitch name determination part and the difference of pitch computation part has a detection means for detecting whether the sample data stored in the latch circuit has been updated, and when it detects the fact that the sample data stored in the latch circuit has been updated during the extracting process of the fundamental period, starts the write control part thereby to write sample data stored in the latch circuit in the data storage part.

20. The tuner as set forth in claim 6, wherein
each of the fundamental period extraction part, the pitch name determination part and the difference of pitch computation part has a detection means for detecting whether the sample data stored in the latch circuit has been updated, and when it detects the fact that the sample data stored in the latch circuit has been updated during the extracting process of the fundamental period, starts the write control part thereby to write sample data stored in the latch circuit in the data storage part.
